(19) United States
(12) Patent Application Publication
(10) Pub. No.: US 2005/0028663 A1
(43) Pub. Date: Feb. 10, 2005

(54) Rotary trimmer with multiple blades

(76) Inventor: Boris Volfson, Huntington, IN (US)

Correspondence Address: BORIS VOLFSON, 5707 W. MAPLE GROVE RD, APT. 3046, HUNTINGTON, IN, 46750, US

(21) Appl. No.: 10/633,860

(22) Filed: Aug. 4, 2003

(51) Int. Cl. B26D 1/18

(52) U.S. Cl. 83/651

(57) ABSTRACT

The rotary trimmer with multiple blades of the present invention comprises a base with end retainers supporting a rail, and a cutting assembly reclinably and slidably disposed on the rail. The different blades having different cutting edges such as a straight, wave, perforating, or zigzag edge, are rotatably mounted on the cutting assembly. The reclining of the cutting assembly provides for the engagement of the blade on the reclined side with the self-healing strip. The sliding of the said cutting assembly against the rail provides for cutting of paper or the like sheet material with the pre-selected blade.

### TECHNICAL FIELD

The technical field of this disclosure is cutting and trimming devices, particularly, a rotary trimmer with multiple blades.

### BACKGROUND OF THE INVENTION

Trimmers are used to cut paper and other sheet materials such as cardboard, leather, fabric, plastics, and similar materials. In a rotary trimmer, a sharp rotary blade, mounted in a housing, is rolled across the cutting board to cut various materials.

Depending on the desired cut, different blades are being used. A straight cut may be desirable for trimming the sheet of paper. A decorative cut with a wave edge may be chosen for craft projects, such as scrapbooks. A zigzag edge may be desirable when cutting fabric to avoid fraying. A perforated cut can be used to make tear away forms. Many patterns are useful or desirable for many different applications and each application requires a different blade.

The rotary trimmers that are known to the art are of two types: those that allow blade replacement, and those having a fixed blade. Those rotary trimmers that allow blade replacement require that one blade be manually replaced with another blade.

The main drawback of the manual replacement is in its complexity: the user dismounts the installed blade, mounts the new blade, and stores the old blade. In many cases, the opening and closing of a housing of the cutting assembly is also required.

The U.S. Pat. No. 5,322,001 to Boda, issued on Jun. 21, 1994, discloses a rotary type trimmer with the replaceable blades having a recess in the cutting board for storing the various cutting blades.

Another drawback of the known trimmers lays in the fact that the user handles an exposed blade at a risk of being cut. Therefore, children are unable to change the cutter and, thereby, the cut pattern.

Still another drawback is in the need to store the blades and the risk that the blades are lost.

It would be desirable to have a rotary trimmer with two, or more then two, blades in the same housing, each blade already positioned perpendicularly to, and in line with, the cutting surface and thereby readily positioned for the immediate deployment.

### SUMMARY OF THE INVENTION

One aspect of the present invention provides a rotary trimmer with multiple blades not requiring a manual blade change.

Another aspect of the present invention provides a rotary trimmer with multiple blades positioned for the immediate deployment.

Still another aspect of the present invention provides a rotary trimmer with blades that can be used by anyone without risking the injury.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 shows a perspective view of a rotary trimmer with multiple blades made in accordance with the present invention.

FIG. 2 shows a perspective view of a cutting assembly of a rotary trimmer with multiple blades made in accordance with the present invention.

FIG. 3 shows a cross-section view of a cutting assembly of a rotary trimmer with multiple blades made in accordance with the present invention.

### DRAWINGS—REFERENCE NUMERALS

1 rotary trimmer
2 base
3 right end retainer
4 left end retainer
5 rail
6 cutting assembly
7 self-healing strip
8 right blade
9 right guard
10 left blade
11 left guard
12 front housing
13 back housing
14 spring
15 pusher
16 slider

### DESCRIPTION OF THE PRESENTLY PREFERRED EMBODIMENT

The rotary trimmer with multiple blades of the present invention comprises a base with end retainers supporting a rail, and a cutting assembly moveably disposed on the rail. The movement of the cutting assembly includes a sliding motion along the rail, and a reclining motion where one side of the cutting assembly is reclining against the rail, and the other side is lifting.

The reclining motion provides for switching between different blades. The different blades can have different cutting edges such as a straight, wave, perforating, or zigzag edge. The reclining motion moves the desired blade downward to engage a self-healing strip. The same motion extends a guard into a position of complete coverage of the exposed blade. The sliding motion rolls the blade along the self-healing strip for cutting paper or another sheet material.

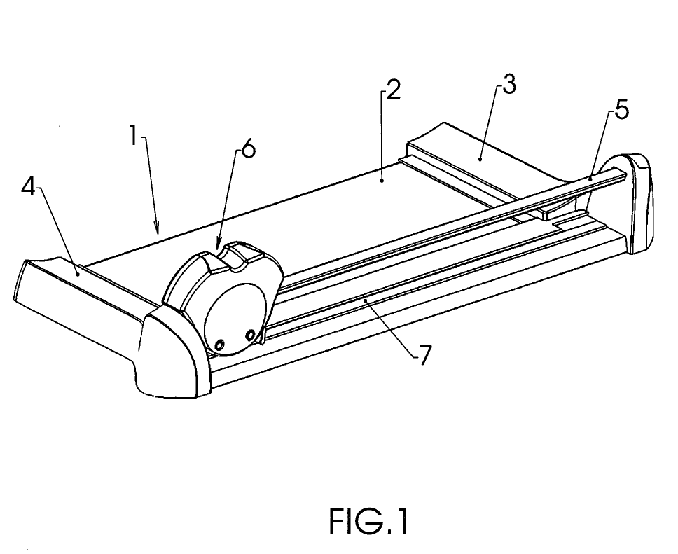

FIG. 1 shows a perspective view of a rotary trimmer with multiple blades made in accordance with the present invention. The rotary trimmer 1 comprises a base 2 sandwiched between right end retainer 3 and a left end retainer 4, a rail 5 slidably supported by these retainers, and a cutting assembly 6 slidably and reclinably disposed on the rail 5. A self-healing strip 7, recessed in the base 2, receives one of the blades during cutting.

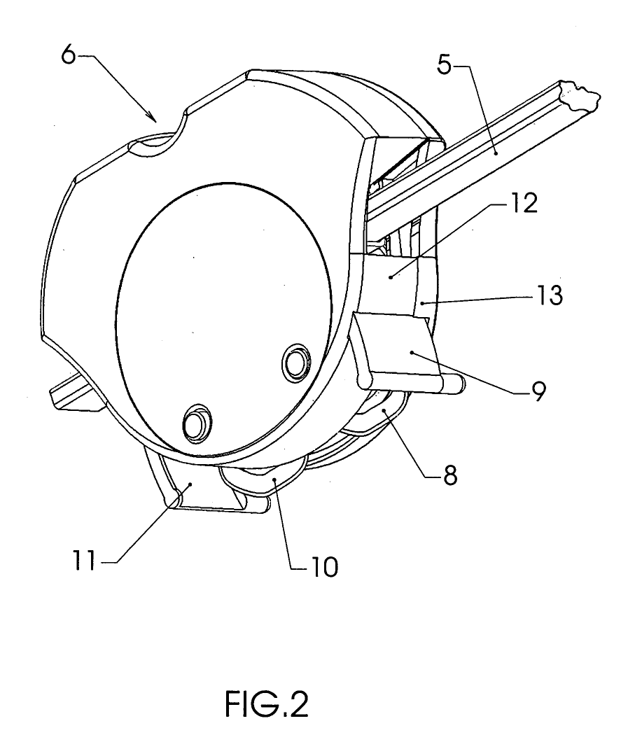

FIG. 2 shows a perspective view of the cutting assembly 6 made in accordance with the present invention. A right blade 8 protected by a right guard 9, and a left blade 10 protected by a left guard 11, are rotatably sandwiched between a front housing 12 and a back housing 13. Although only two blades are presented on the preferred embodiment, those skilled in the art will appreciate that more than two blades can be employed without departing from the spirit of the invention.

The right guard 9 and the left guard 11 are slidably sandwiched between the front housing 12 and the back housing 13.

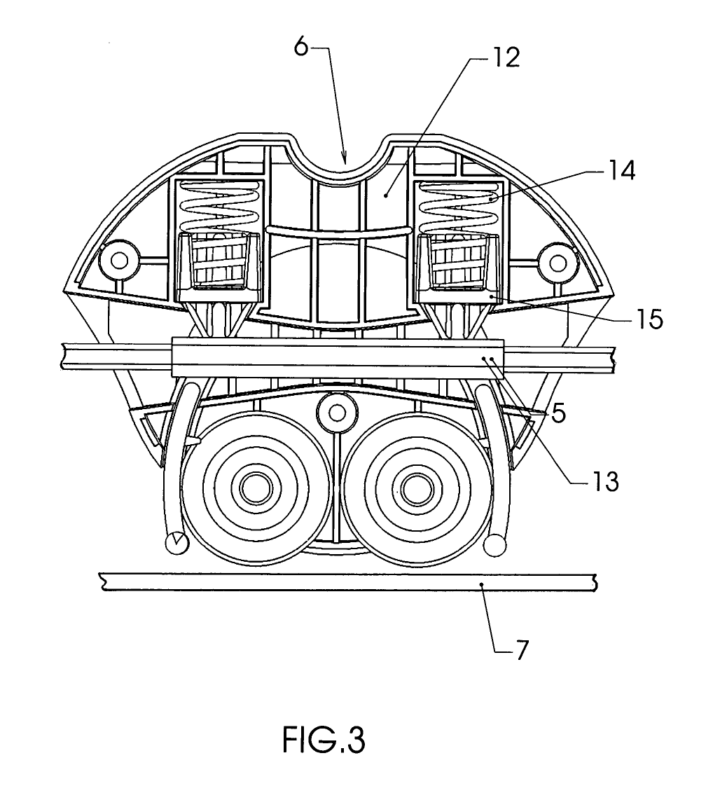

FIG. 3 shows a cross-section view of the preferred embodiment of the cutting assembly made in accordance with the present invention. The front housing 12 has two compartments each receiving a spring 14 with a pusher 15. A slider 16 is slidingly assembled on the rail 5 and rotatably sandwiched between the front housing 12 and the back housing 13. By bottoming out against the slider 16, the pushers provide for a non-cutting position of the cutting assembly 6 with both blades positioned above the self-healing strip.

The application of force to one of the sides of the cutting assembly 6 results in the reclining of this side of the cutting assembly 6 against the base with the blade on the reclining side engaging the healing strip 7. Simultaneously, the guard of the lifting side of the cutting assembly 6 is forced outward by the slider 16 into a position where it provides a full protection for user from the exposed blade.

The following sliding motion of the reclined cutting assembly 6 along the rail 5 provides for a cut with the pre-selected blade.

1. A rotary trimmer comprising:
a right end retainer;
a left end retainer;
a base, the base sandwiched between the said left end retainer and the said right end retainer;
a self-healing strip, the self-healing strip recessed in the said base;
a rail, the rail slidably supported from both sides by the said left end retainer and the said right end retainer;
a cutting assembly, the cutting assembly reclinably and slidably disposed on the said rail;
a right blade, the right blade disposed on the right side of the cutting assembly perpendicularly to, and in line with, the said self-healing strip;
a left blade, the left blade disposed on the left side of the cutting assembly perpendicularly to, and on line with, the said self-healing strip,
whereby the reclining of the said cutting assembly on the said rail provides for the engagement of the pre-selected blade with the said self-healing strip,
whereby the sliding of the said cutting assembly against the said rail provides for cutting of paper or the like sheet material with the pre-selected blade.

2. The said cutting assembly of claim 1 comprising:
a front housing;
a back housing;
a slider, the slider reclinably sandwiched between the said front housing and the said back housing, said slider slidingly disposed on the said rail;
a right guard, the right guard slidably sandwiched between the said front housing and the said back housing, said right guard having an upper edge in-contact with the said slider,
said right guard positioned to protect the user from the said right blade;
a left guard, the left guard slidably sandwiched between the said front housing and the said back housing, said left guard having an upper edge in-contact with the said slider, said left guard positioned to protect user from the said left blade;
whereby the reclining of the cutting assembly forces the outward extension of the guard into a position of full protection of user from the exposed blade.

3. The cutting assembly mechanism of claim 1 wherein the said cutting assembly has more than two blades.
